(19) United States
(12) Patent Application Publication
(10) Pub. No.: US 2011/0035442 A1
(43) Pub. Date: Feb. 10, 2011

(54) Adaption of Metadata Based on Network Conditions

(75) Inventors: Johan Hjelm, Tokyo (JP); Takeshi Matsumura, Kawasaki (JP); Shingo Murakami, Kanagawa (JP); Toshikane Oda, Tokyo (JP)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/936,845

(22) PCT Filed: Apr. 10, 2008
(86) PCT No.: PCT/SE2008/000264

§ 371 Date: Oct. 7, 2010

(51) Int. Cl. G06F 15/16

(52) U.S. Cl. 709/203; 709/217

(57) ABSTRACT

In methods and arrangements for adapting metadata depending on conditions in a network or at user equipment (100, 200, 300) and for using such adapted metadata, for example information about the traffic conditions in a network can he used to adapt metadata to comprise, or to comprise references to, such media content that is suitable regarding the network conditions. Different versions, having different bandwidth requirements, of the media content, may for example be used.

### TECHNICAL FIELD

The present invention relates to metadata and more specific to methods of and arrangements for providing adapted metadata.

### BACKGROUND

In the background art it is known to transmit media streams in communication networks. Media streams are e.g. transmitted to users in television or video-on-demand systems. One problem is that conditions in a communication network may change. When a media stream is transmitted in a communication network and the available transmission capacity is reduced or the demand for transmission capacity is high, it may require a considerably longer time to transmit a given media stream than when the transmission capacity is at a normal level or when the demand for transmission capacity is low.

This situation is a problem for the user who sometimes may receive a media stream with good viewing quality but at other times may receive a media stream where e.g. delays in the transmission influences the displaying of the media stream negatively. Also for the party delivering the media stream this situation is disadvantageous since it may create a negative impression of this party if the transmissions are bad. Also the impression may arise that the party delivering the media stream promises more that it can deliver. For the operator of the communication network this situation also is disadvantageous, it is e.g. difficult to manage the network when there are big changes in the demand for transmission capacity. At times when a lot of users want to download media streams the demand rises quickly but the network operator have no possibility to influence this demand. The network operator must simply try to manage the network as good as possible to meet the demand.

Another problem is that conditions at the user equipment may vary between different user equipments. When a media stream is transmitted it has to be transmitted in a format making the media stream suitable to be displayed on a number of different user equipments with different technical characteristics. This is however often a compromise. This situation is disadvantageous for the user since the media stream often is not optimally, or at least not well, adapted to the user equipment which may result in a poor viewing experience for the user. This situation is also negative for the party delivering the media stream since a bad viewing experience for the user may create a negative impression of the party delivering the media streams.

### SUMMARY

It is an object of the present invention to address the problems outlined above. This object and others may be obtained by providing methods and arrangements according to the independent claims attached below. In the method described herein metadata is used. Metadata is previously known and is data about other data. Metadata may e.g. be data relating to media streams. More specifically, in the method as described herein, metadata is adapted to contain references to, or information about, such media streams or media content that are suitable, taking the current conditions into account. The conditions may e.g. be network conditions or conditions relating to user equipment. One example of metadata used in the method is an Electronic Program Guide (EPG), which may contain metadata about several media streams.

According to one aspect, there is provided a method which is executed in a metadata server node connected to or in a communication network. The communication network is among other things adapted to deliver media streams from a media server node to user equipment. In the method metadata is provided which is transmitted from the metadata server node to the user equipment and which is related to media content. The method may comprise the following steps:

receiving status information relating to conditions in the communication network and/or in the user equipment,
generating the metadata wherein the metadata is adapted to the status information, or adapted considering the status information. The adaptation of the metadata can also be described as being based on the status information, and
transmitting the generated metadata to the user equipment.

According to one embodiment of the method executed in a metadata server node, the metadata is adapted to contain information about, or to contain references to, such media content that is suitable considering the status information.

According to another embodiment of the method executed in a metadata server node, the status information is received from the media server node.

According to a further embodiment of the method executed in a metadata server node, the status information is received from the user equipment.

According to a yet a further embodiment of the method executed in a metadata server node, the conditions include at least one of: transport conditions, user equipment conditions and user equipment device characteristics.

According to another embodiment of the method executed in a metadata server node, status information is used that is related to the transmission of a media stream from the media server node to the user equipment. This use of status information may be done in the step of generating the metadata.

According to a further embodiment of the method executed in a metadata server node, status information is used that is related to the conditions at the user equipment. This use of status information may be done in the step of generating the metadata.

According to yet another advantageous embodiment of the method executed in a metadata server node, the status information comprises user equipment device characteristics.

According to another aspect, there is provided an arrangement in a metadata server node connected to or in a communication network. The communication network is among other things adapted to deliver media streams from a media server node to user equipment. The arrangement is among other things adapted to provide metadata which is transmitted from the metadata server node to the user equipment and which is related to media content. The arrangement may comprise the following elements:

a first receiving element for receiving status information relating to conditions in the communication network and/or in the user equipment,
a metadata generating element for generating the metadata. The metadata is adapted to, or considering, the status information. The adaptation of the metadata can also be described as being based on the status information, and
a first transmitting element for transmitting the generated metadata to the user equipment.

According to one embodiment of the arrangement in a metadata server node, the metadata generating element is adapted to adapt the metadata to contain references to such media content that is suitable considering the status information.

According to another embodiment of the arrangement in a metadata server node, the first receiving element is adapted to receive status information from the media server node.

According to a further embodiment of the arrangement in a metadata server node, the first receiving element is adapted to receive status information from the user equipment.

According to yet another embodiment of the arrangement in a metadata server node, the first receiving element is adapted to receive status information relating to conditions which include at least one of: transport conditions, user equipment conditions and user equipment device characteristics.

According to yet a further embodiment of the arrangement in a metadata server node, the metadata generating element is adapted to use status information that is related to the transmission of a media stream from the media server node to the user equipment.

According to another embodiment of the arrangement in a metadata server node, the metadata generating element is adapted to use status information that is related to the conditions at the user equipment.

According to a further embodiment of the arrangement in a metadata server node, the metadata generating element is adapted to use status information that is related to user equipment device characteristics.

According to yet another aspect, there is provided a method which is executed in user equipment connected to, or in, a communication network. The communication network is among other things adapted to deliver media streams from a media server node to user equipment. In the method metadata is used, which is received at the user equipment from a metadata server node and which is related to media content. The method may comprise the following steps:

receiving adapted metadata. The metadata has been adapted to, or adapted considering, status information. The adaptation of the metadata can also be described as having been based on the status information,
personalizing the adapted metadata using user profile information,
transmitting the personalized adapted metadata to a media client. The media client is adapted to receive media content, to process media content and to output media content to a display device so that the media content can be viewed by a user, and
displaying media content to a user,
wherein the displayed media content comprises the personalized adapted metadata, and/or wherein the displayed media content is selected by using or utilising the personalized adapted metadata.

According to one embodiment of the method executed in a user equipment, the following may be performed:

sending a request for transmission of media content from the user equipment to the media server node or to the metadata server node. The requested media content is requested on the basis of, or using, the personalized adapted metadata.
This request may be sent in the step of displaying media content to a user.

According to another embodiment of the method executed in a user equipment, assertions are derived by the parsing of logical statements which are present in the received adapted metadata. This may be performed in the step of personalizing the adapted metadata.

According to a further embodiment of the method executed in a user equipment, user profile information in the form of rules are applied to the derived assertions. Thereby personalized adapted metadata is created. This may be performed in the step of personalizing the adapted metadata.

According to a further aspect, there is provided an arrangement in user equipment connected to or in a communication network. The communication network is among other things adapted to deliver media streams from a media server node to user equipment. The arrangement is among other things adapted to use metadata which is received at the user equipment from a metadata server node and which is related to media content. The arrangement may comprise the following elements:

a second receiving element for receiving adapted metadata. The metadata has been adapted to, or adapted considering, status information. The adaptation of the metadata can also be described as having been based on the status information,
a personalizing element for personalizing the adapted metadata using user profile information,
a second transmitting element for transmitting the personalized adapted metadata to a media client. The media client is adapted to receive media content, to process media content and to output media content to a display device so that it can be viewed by a user, and
a media client for displaying media content to a user by outputting media content to a display device,
wherein the displayed media content comprises the personalized adapted metadata, and/or wherein the displayed media content is selected based on the personalized adapted metadata.

According to one embodiment of the arrangement in a user equipment, the media client is adapted to send a request for transmission of media content. The request is sent from the user equipment to the media server node or to the metadata server node. The request concerns transmission of media content to the user equipment. The requested media content is requested on the basis of the personalized adapted metadata.

According to another embodiment of the arrangement in a user equipment, the personalizing element is adapted to derive assertions by parsing of logical statements which are present in the received adapted metadata.

According to a further embodiment of the arrangement in a user equipment, the personalizing element is adapted to apply user profile information in the form of rules to the derived assertions. Thereby personalized adapted metadata is created.

Generally, the methods and devices described herein concern metadata that is adapted to conditions of some sort. Specifically, a method and arrangement in a metadata server node and a method and arrangement in user equipment are described herein.

Further possible features and benefits of the present invention will be explained in the detailed description below.

### BRIEF DESCRIPTION OF THE DRAWINGS

The invention will now be described by way of non-limiting exemplary embodiments and with reference to the accompanying drawings in which:

FIG. 1 is a schematic diagram illustrating a procedure for generating and using adapted metadata according to a first embodiment,

FIG. 2 is a block diagram illustrating a procedure for generating and using adapted metadata according to a second embodiment,

FIG. 3 is a block diagram illustrating a procedure for generating and using adapted metadata, according to a third embodiment,

FIG. 4 is a block diagram of a first arrangement for adapting metadata, and

FIG. 5 is a block diagram of a second arrangement for using adapted metadata.

### DETAILED DESCRIPTION

Before exemplary embodiments are described in detail, it is to be understood that this invention is not limited to the particular component parts of the arrangements described or method steps of the methods described as such arrangements and methods may vary. It is also to be understood that the terminology used herein is for purposes of describing particular embodiments only, and is not intended to be limiting. It must be noted that, as used in the specification and the appended claims, the singular forms “a,” “an” and “the” also include plural referents unless the context clearly dictates otherwise. Thus, for example, reference to “an element” includes more than one such element, and the like.

In the figures, all elements are parts of or are connected to a communication network. With elements are meant e.g. the user equipment 100, 200, 300 including its various components, the metadata server node 102, 202, 302, the media server node 104, 204, 304, the transport network 106, 206, 306 and the profile database 208, 308.

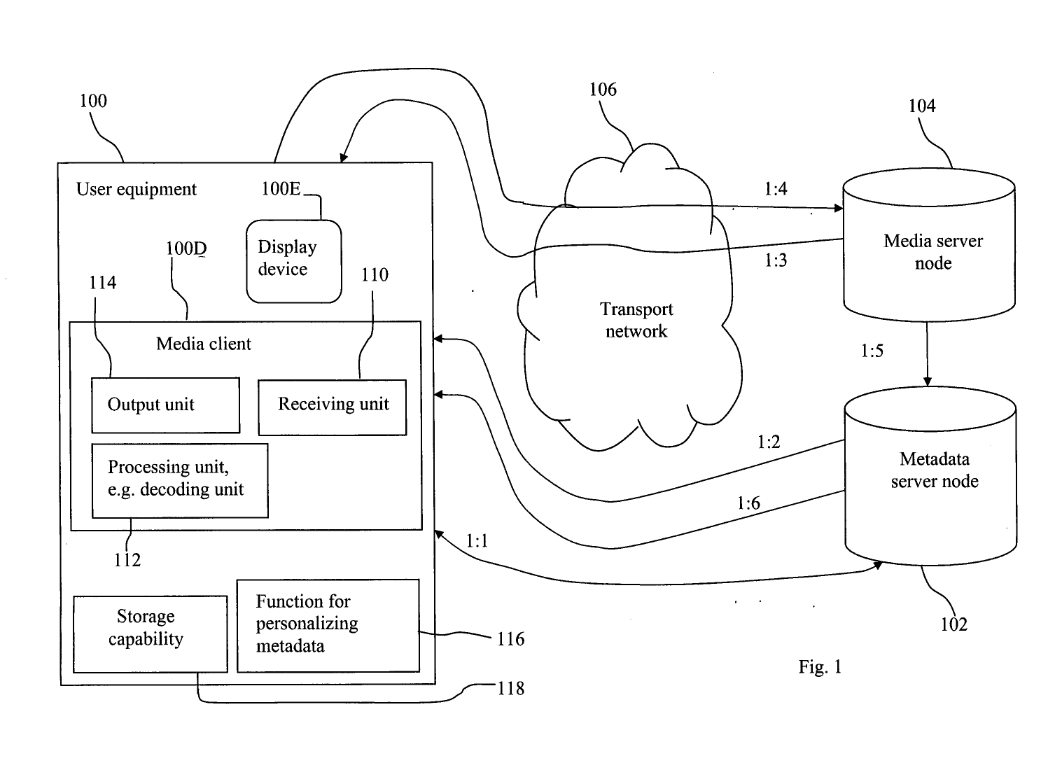

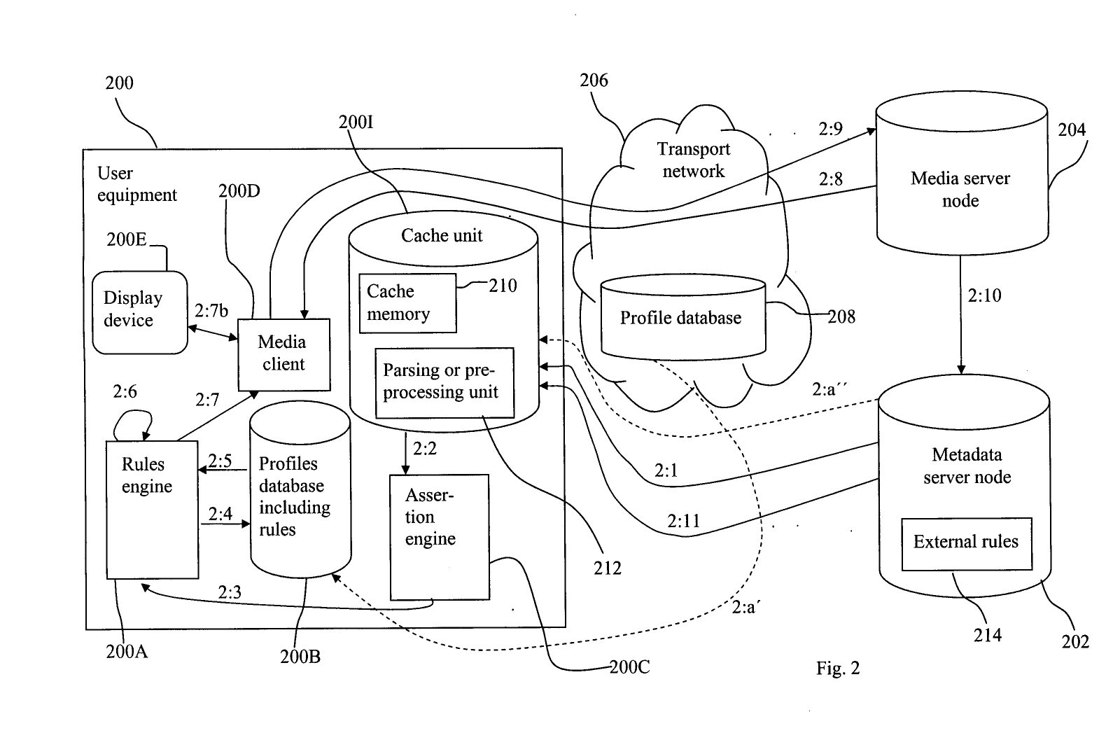

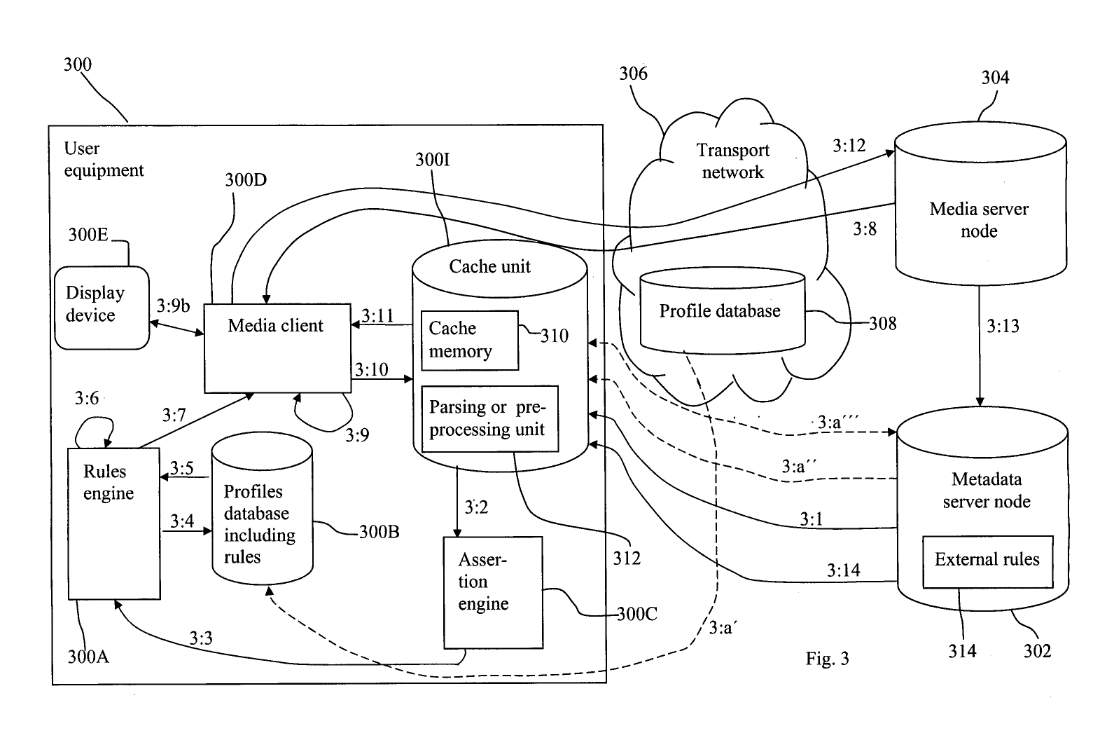

A method for adapting metadata will now be described with reference to FIG. 1. Later in this description the method will be further elucidated in more specific examples, with reference to FIGS. 2 and 3. In FIG. 1 user equipment 100 is shown which could be any kind of equipment comprising some viewing functionality, i.e. a viewing unit such as a display device 100E. It may be a portable unit such as e.g. a mobile telephone, a portable computer or a Personal Digital Assistant (PDA), or a non-portable unit such as e.g. a television set or a non-portable computer.

The user equipment 100 may comprise a viewing unit or display device 100E, a function 116 for personalizing the metadata, a media client 100D and storage capability 118 of various types. The media client 100D may e.g. comprise a receiving unit 110, a processing unit 112, e.g. a decoding unit, and an output unit 114 adapted to output media streams to the viewing unit or display device 100E. The receiving unit 110 is adapted to receive media content and the processing unit 112 is adapted to process media content, e.g. to decode media content. The media client 200D, 300D described in FIGS. 2 and 3 may have the same functionality and components as the media client 100D in FIG. 1.

When a connection between the user equipment 100 and a metadata server node 102 is established, information about the user equipment 100 may be transmitted to the metadata server node 102. If conditions at the user equipment 100 change, updated information about the user equipment 100 is sent to the metadata server node 102. The metadata server node 102 may comprise an arrangement 400 in a metadata server node, the arrangement 400 comprising a first receiving element 402, a metadata generating element 404 and a first transmitting element 406. Information about the user equipment 100 may be received by a first receiving element 402 in the metadata server node 102.

A metadata document may be sent from the metadata server node 102 to the user equipment 100. This may e.g. take place when a user starts a session of TV-viewing. The user may actively request an Electronic Program Guide (EPG) or the TV-system may automatically send an EPG to the user. Such an EPG is one example of a metadata document that may be sent from the metadata server node 102 to the user equipment 100. A metadata document that is sent from the metadata server node 102 may be sent by a first transmitting element 406 in the metadata server node 102.

When a metadata document is composed, it is adapted to different conditions, according to the described method. Preferably such adaptation is performed at the metadata server node 102. The metadata document may be composed and adapted by the metadata generating element 404 in the metadata server node 102. The mentioned conditions may be network conditions such as transport conditions, or user equipment conditions, e.g. relating to characteristics of the user equipment 100. The transport conditions may relate to a transmission from the media server node 104 to the user equipment 100. A transport quality report relating to such transport conditions may be sent from the media server node 104 to the metadata server node 102, where it may be received by the first receiving element 402. In the metadata server node 102 the information in the transport quality report is used in the adaptation of the metadata. If the metadata document is an EPG, it may comprise references, e.g. links, to media streams stored at the media server node 104. The adaptation of the metadata document may in this case comprise changing the references in the EPG depending on the contents of the transport quality report. If the transport quality report contains information that the capacity of the communication connection from the media server node 104 to the user equipment 100 is low, the EPG may be provided with references or links to media streams having a relatively low resolution, and hence only requiring a relatively low transmission capacity. On the other hand, if the transport quality report contains the information that the capacity of the communication connection from the media server node 104 to the user equipment 100 is high, the EPG may be provided with references or links to media streams having a relatively high resolution, and hence requiring a relatively high transmission capacity.

For a transport quality report to be established, a media stream must first be transmitted. Hence, one possibility is that when a session is initiated, shown at 1:1, by the user equipment 100, the metadata server node 102 sends an unadapted metadata document, e.g. an unadapted EPG, to the user equipment 100, shown at 1:2. Using this metadata document, a certain media stream is selected at the user equipment 100, e.g. by a user, and the transmission of the selected media stream, shown at 1:3, from the media server node 104 to the user equipment 100 is started. During the transmission of the media stream, transport quality reports are established by the user equipment 100 and sent, shown at 1:4, to the media server node 104. The media server node 104 forwards these transport quality reports to the metadata server node 102, shown at 1:5, which, as soon as the first transport quality report arrives, may use the transport quality reports to adapt the metadata document. The adapted metadata document is then transmitted to the user equipment 100, shown at 1:6. An updated metadata document may be transmitted by the metadata server node 102 every time when a transport quality report is received, or the metadata server node 102 may compare the most recent version of the metadata document, resulting from the most recently received transport quality report, to the previous version of the metadata document, and only transmit a metadata document in the case where the two versions of the metadata document differ. The adapted metadata document sent from the metadata server node 102 can be regarded as an update of the previously transmitted metadata document. Hence, less processing may be required at the user equipment 100 when receiving such a metadata document as compared to receiving the firstly received metadata document.

The metadata document may also be adapted to conditions relating to characteristics of the user equipment 100. Such characteristics may e.g. be: i) the size or orientation of the viewing unit, e.g. screen, ii) the functionality of a possible decoder, iii) information about the available input methods, e.g. including a keyboard, joystick, mousepad, touchscreen, microphone, which is relevant e.g. if the media stream is or includes an interactive application, iv) the available output methods, e.g. if earphones or speakers are used for sound output, v) the possibility to measure ambient light, and if yes, the intensity level of ambient light. Information about the characteristics of the user equipment 100 may be transmitted from the user equipment 100 to the metadata server node 102 when the session or connection between the user equipment 100 and the metadata server node 102 is established. It is also possible to implement a function in the user equipment 100 that sends a message, e.g. an SIP (Session Initiation Protocol) message, to the metadata server node 102 when some defined or predetermined characteristic at the user equipment 100 changes. Such a message then contains information about the changed characteristic at the user equipment 100. At the metadata server node 102, the information about the user equipment 100 is used to adapt the metadata document to the characteristics of the user equipment 100. The metadata document may of course, as described above, also be adapted to transport conditions in the network.

One characteristic at the user equipment 100 that could be used in adapting the metadata, is the decoding functionality of a possible decoder, e.g. a decoding unit 112, at the user equipment 100. It may be the case that such a decoder supports a certain encoding scheme, e.g. MPEG2 or MPEG4 (MPEG=Moving Picture Experts Group) and then it may be advantageous if the metadata document is adapted to contain references to media streams which are encoded using the same encoding scheme as that used by the decoder. Another characteristic at the user equipment 100 that could be used in adapting the metadata, is the size of the viewing unit or display device 100E, e.g. a computer monitor. There may be stored media streams at the media server node 104 which are adapted to different screen sizes and it may be advantageous if the metadata document is adapted correspondingly so that the media stream which is transmitted to the user equipment 100 is adapted to the size of the viewing unit or display device 100E at the user equipment 100.

In the arrangement in a metadata server node 400 in the metadata server node 102, an update function 408 may be implemented with the effect that an updated metadata document is transmitted to the user equipment 100, or to a group of several user equipments 100, each time when some content that is part of the metadata document changes. Such a change may depend on changes in e.g. network transport conditions or user equipment characteristics. The updated metadata document may be sent as an SIP message. It is also possible to use a subscribe-notify solution therefore. The user equipment 100 then subscribes with the metadata server node 102 to receive updated metadata document(s) from the metadata server node 102 when some content that is part of the metadata document changes. Such an updated metadata document may also be sent as an SIP message. To use a subscribe-notify solution requires a notifying agent for each user equipment 100, or groups of user equipments 100, to be defined in the metadata server node 102. By sending an updated metadata document only when some content that is part of the metadata document has changed, the number of metadata document transmissions is potentially reduced as compared to the situation wherein an updated metadata document is sent every time when a transport quality report is received by the metadata server node 102. It might be the case that when a transport quality report is received at the metadata server node 102, this report does not result in any change in the metadata document. In that case it is unnecessary to send an updated metadata document.

With reference to FIG. 2, a further embodiment of the method described herein now will be described. This embodiment relates to personalized metadata which is one example of a situation where the method is advantageous to use. In this embodiment two assumptions are made. First, it is assumed that the metadata document is composed of one or more XML (eXtensible Markup Language) document(s). If the metadata document is composed of more than one XML document, this implies that the XML documents can be merged in well-established ways, which allows further processing to take place. The fact that the metadata document includes XML documents implies that there is a parser, e.g. a parsing or pre-processing unit 212 in the user equipment 200, which can go through the XML document(s) and process any element that requires processing. This is according to the XML standard. The possibility to include documents from other or different XML namespaces, or, indeed, binary elements, in the XML document is also according to the XML standard. In this embodiment, the assumption is made that the metadata document is a regular XML-document, which contains e.g. XHTML (eXtensible Hyper Text Markup Language) and/or TV-Anytime code (TeleVision-Anytime) and/or MPEG-7 DDL (Moving Picture Experts Group-7 Description Definition Language), which can be parsed and displayed to an end-user.

A second assumption is that the metadata document contains embedded statements in an ontology which conforms to the OWL (Web Ontology Language), which implies that statements can be processed and assertions derived from the statements. Statements may be of the form “all ravens are black”—“Aristotle is a raven”—“therefore Aristotle is black”.

The metadata document, which can consist of elements that contain either parameters or URI:s (Universal Resource Identifiers), is parsed when downloaded into the cache unit 200I. As indicated in FIGS. 2 and 3 the cache unit 200I, 300I may comprise a cache memory 210, 310 and a parsing or pre-processing unit 212, 312. The metadata document is downloaded into the cache memory 210, 310, then parsed or pre-processed in the parsing or pre-processing unit 212, 312 and then stored in the cache memory 210, 310 from which it can be handed over to the assertion engine 200C, 300C. Any URI:s which are referenced in the metadata document are de-referenced, i.e. any documents or fragments which they reference are fetched. This may be done as an HTTP request-response operation. The metadata document is in this way composed and stored in the cache memory 210, 310 until it is required. This can be done either as an integrated part of the method of adapting the metadata as described below in steps 2:1-2:11 in FIG. 2 or as part of a separate operation as described below in steps 2:a′ and 2:a″ in FIG. 2.

If a profile information document stored in the profile database 208 comprises multiple XML documents, they can originate from multiple sources and be aggregated at the user equipment 200. The multiple XML documents may e.g. be stored in additional databases, not shown, connected to the profile database 208, where the profile information document contains pointers to the XML documents in the additional databases.

One advantage of performing part of the personalization at the user equipment 200 is that the user equipment 200 is not controlled by the service provider(s) involved in the system. This may have two advantages:

A. It provides privacy.

B. It is less complex to make the personalization at the user equipment. Reason: The network operator/provider may not be the same as the service provider, and hence may not have access to the same profile information as the user, who, as can be assumed, has all his/hers profile information. If the personalization should be done somewhere in the network, the network operator must have all the profile information of the user. Otherwise it is not possible to do all the personalization of the metadata, and hence, also of the media stream, before sending the media stream to the user. It would be difficult and cumbersome for the network operator to collect all the profile information of the user.

In most cases it is not possible to personalize the media stream at the user equipment 100, 200, 300 since the media stream is encoded.

The metadata server node 102, 202, 302, the media server node 104, 204, 304 and the profile database 208, 308 could be run by the same service provider or they could all be run by different service providers, or two or more of them could be run by the same service provider in different constellations.

It would be possible to do the entire personalization on the network side, but it is more complicated, especially in the case of multiple profiles which would have to be merged. It should be noted that the merging of multiple profiles and rule sets is not trivial, since one would have to aggregate user profiles which would mean having agreements with all the service providers for or with which the user might have profiles.

The metadata server node 202 may comprise an arrangement 400 in a metadata server node, the arrangement 400 comprising a first receiving element 402, a metadata generating element 404 and a first transmitting element 406. Transport quality reports or status reports may be received by the first receiving element 402 in the metadata server node 202. A metadata document may be composed and adapted by the metadata generating element 404 in the metadata server node 202. A metadata document that is sent from the metadata server node 202 may be sent by the first transmitting element 406 in the metadata server node 202.

In the embodiment presently described, the method works as follows, the steps being illustrated in FIG. 2:

It is assumed that a user connects to a system for transmitting media streams, e.g. an IPTV system (Internet Protocol TeleVision system) or VOD system (Video On Demand system). By doing that the user starts a session. A session may hence be one occasion of television viewing. After a session has been started, first two asynchronous operations may take place:

2:a′: The user profile, stored in the profiles database with rules 200B, at the user equipment 200 is updated with the latest rule set from the profile database 208. This step is asynchronous and can take place at any time.

2:a″: The cache unit 200I is provided with metadata by transmitting a metadata document from the metadata server node 202 to the user equipment 200. This can be done asynchronously from the process of transmissions and actions described below in steps 2:1-2:11. The asynchronous transmission 2:a″ of a metadata document may take place as a result of a session having been initiated, i.e. without a user having specifically requested such information, such information being e.g. an EPG. This transmission may be effected so that the cache unit 200I is provided with an EPG already before the user has requested an EPG. When the user at some point requests an EPG it is already stored in the cache unit 200I and can be quicker provided to the user. The asynchronous transmission 2:a″ of a metadata document may also take place because an update of the metadata document is necessary. It may e.g. be the case that a TV-program has been exchanged for another. In that case the system will initiate the transmission of a metadata document comprising the updated information so that a correct EPG can be displayed to the user.

It would also be possible to change step 2:a′ so that the information that is sent from the profile database 208 is sent to the metadata server node 202 instead of to the user equipment 200. In this case step 2:a″ would be performed before step 2:a′. However, this would mean that the metadata document sent from the metadata server node 202 to the user equipment 200 would contain more data which would make the transmission thereof more bandwidth consuming which may be unfavourable in some situations. The metadata document would also be adapted both to the personal profile and to conditions, e.g. network conditions, which would make it more complex to put together the metadata document, which may not be favourable as well.

However, the process wherein metadata is adapted based on some conditions, e.g. network conditions, is triggered by an additional metadata document being sent as will be described in step 2:1. It is assumed that this metadata document is transmitted as a result of a user request of some kind, e.g. a user request for an EPG, where the user request eventually will result in a media stream being transmitted to the user equipment 200. This request can be made automatically by the Media client 200D or another suitable client in the user equipment 200. Which version of the media stream that is transmitted to the user equipment 200 can be controlled by adapting the metadata document. In the metadata document it can e.g. be included a version, or a reference to a version, of the media stream which has relatively low bandwidth requirements if the network conditions are bad.

Then, when the process is actually started, the following takes place:

2:1: A metadata document is sent to the user equipment 200, and hence to the cache unit 200I where it is stored in the cache memory 210. This can be done in a number of ways, the metadata document may be sent as an HTTP (HyperText Transfer Protocol) message containing XML document(s). But it may also be sent as an SIP message containing XML document(s). In the following, it is assumed that the metadata document is sent as an SIP message containing XML document(s). The metadata document may be sent by the first transmitting element 406 in the metadata server node 202.

a. This metadata document is not adapted to the user's preferences, the network transport conditions or any other conditions. Since the network transport conditions are not known, adaptation with regard to these can be done only after reception of the media stream has occurred, i.e. in step 2:10 in which the transport quality report is sent to the metadata server node 202.

b. In steps 2:2 to 2:7 to be described below, the personalization process and the preparation of the metadata document for display takes place.

c. The metadata document, in the form of an SIP message, which is received at and stored in the cache unit 200I can be routed internally in the user equipment 200 by a SIP stack, not shown, in the user equipment 200, or the cache unit 200I can be the normal receiver of SIP messages.
i. The metadata document contains an XML document which will be pre-processed or parsed by the parsing or pre-processing unit 212 in the cache unit 200I. Normally, an XML document is not processed or parsed until it is to be used or displayed. In this case, however, the cache unit 200I does pre-processing or parsing as described above, to allow the personalization of the metadata document.
ii. It is possible to calculate the current delay of delivery from the origin server, e.g. the metadata server node 202, to the cache unit 200I using the HTTP Age header value if the metadata document is sent as an HTTP message. In other protocols than HTTP, functions similar to the HTTP Age header can be used or added to calculate the current delay of delivery. The delay of delivery can be used in step 2:9, described below, and be sent to the media server node 204 along with the information in the transport quality report. Either the current value of the Age header field is used, or an average of several values of the Age header field is used. The sub-process initiated in step 2:9 could thus potentially be applied to the first download from the media server node 204 to the user equipment 200, if latency can be assumed to be constant and consistent, e.g. if the average value of the HTTP Age header field is close to the measured values, the measured values coming from the transport quality report.

2:2: After the pre-processing or parsing, in the parsing or pre-processing unit 212 in the cache unit 200I, the metadata document is handed over to the assertion engine 200C. The pre-processing or parsing in the cache unit 200I includes parsing the XML statements in the metadata document, i.e. translating the. XML-format to a format that for instance can be used by the other processes. This implies e.g. taking the text format and extracting the variables which have to be input into the appropriate programs, and so on.

2:3: The assertion engine 200C derives the assertions from the ontology statements in the metadata document received from the cache unit 200I and hands the assertions over to the rules engine 200A.

2:4: The rules engine 200A requests the rules from the profiles database including rules 200B.

a. The rules in the profiles database including rules 200B can be pre-provisioned, meaning that the operator or service provider, of the profile database 208, loads the rules into the profiles database including rules 200B at some earlier point of time.

b. A central database for profile management can be used, such as an HSS (Home Subscriber Server) or an OMA XDMS (Open Mobile Alliance XML Document Management Server). For example, the profiles database including rules 200B can be implemented as an OMA XDMS database.

2:5: The rules are retrieved from the profiles database including rules 200B into the rules engine 200A. The rules may be implemented using RuleML (Rule Markup Language).

2:6: The rules engine 200A applies the rules to the assertions derived in step 2:3.

a. The rules may be individual or personal, which means that when the individual or personal rules are applied to the common assertions, a set of individualized or personalized metadata is created.
i. This metadata may be e.g. an electronic program guide (EPG), displaying the favourite programs of the user. If, for instance, an assertion derived from the statements in step 2:3 is “Aristotle is black”, and a user A has a rule which says “include all Greek philosophers in my EPG”, and a user B has a rule which says “exclude everything that is not white from my EPG”, then the EPG of user A will display “Aristotle” whereas the EPG of user B will not display anything from this assertion.

2:7: The created or derived personalized or individualized metadata, e.g. a personalized EPG, is transmitted to the media client 200D and displayed to the user by the media client 200D outputting, shown at 2:7b, the EPG to the display device 200E.

a. The user then selects to view a program from the personalized or individualized metadata, e.g. a personalized EPG.

2:8: The media stream comprising the program selected by the user is transmitted, e.g. following a request from the user equipment 100, 200, 300 to the media server node 104, 204, 300, to the user equipment 200. and displayed to the user. For the transmission e.g. a protocol such as the RTP (Real-time Transport Protocol) may be used.

2:9: As part of the reception process, a status report with status information, e.g. information on transport conditions, is sent from the user equipment 200 to the sender, i.e. the media server node 204, a streaming server.

a. The status report may be sent using a standardized protocol, e.g. the RTP Control Protocol (RTCP), this being a receiver quality report. When this protocol is used the status report comprises information on network conditions, e.g. transport conditions. But the status report may also comprise information on other conditions in relation to which it is relevant to adapt the metadata document.

2:10: In this step the status report generated and transmitted in step 2:9 is sent from the media server node 204 to the metadata server node 202. In the metadata server node 202 the status report may be received by the first receiving element 402. Based on the network conditions described in the status report, the metadata server node 202 generates a new and updated XML metadata document. The metadata document may be composed and adapted by the metadata generating element 404 in the metadata server node 202.

a. What is created at the network side, in the metadata server node 202, is a “raw” metadata document, to which items can be added or changed on the client side, in the user equipment 200. One possibility is to use groups, so that one common metadata document is created for a group of user equipments 200 and transmitted to that group. Then the individual adaptation in each user equipment 200 is done on the common metadata document. Groups can be handled within XDMS (XML Document Management Server), e.g. as multicast groups.

b. There may be a set of pre-provisioned external rules 214, 314 that describe how the metadata document should be composed, the metadata document being composed in the metadata server node 202, depending on the conditions, e.g. traffic of transport conditions, in the network.
i. for instance, if the latencies are extensive, the system, e.g. the metadata server node 202, could be set to exclude any real-time events, or references to real-time events, from the metadata document, and/or
ii. variant encodings can be selected: for instance, low bandwidth encoding in the case where the available bandwidth is low, or forward error correction (FEC) can be added in case latencies are high and there is a high risk of packets being lost.

The pre-provisioned external rules 214, 314 may be defined and provided by the service provider running the metadata server node 202. The pre-provisioned external rules 214, 314 may be stored in the metadata server node 202.

2:11: The metadata server node 202 sends the new or updated metadata document to the user equipment 200. This metadata document does not need to be complete, and may include only the parts of the metadata document that need to be updated taking the status report into account. In the user equipment 200 this updated metadata document then is merged with the previously received metadata document. A metadata document that is sent from the metadata server node 202 may be sent by the first transmitting element 406 in the metadata server node 202.

At the user equipment 200 the steps 2:2 through 2:7 are then applied to the new or updated metadata document, to create a unique personalization for the user.

In this embodiment the example of metadata is an Electronic Program Guide, EPG. It is possible to apply the method as described to any kind of information which allows selection of variants of content. One possibility is to use this method of adapting metadata as input to a transcoder, hence creating a version of the content that is adapted to the conditions present at the users device. Another possibility is to apply the described method to any content list where variants can be selected, for instance games which can be played on multiple platforms and using different interaction methods, e.g. full first-person-shooter interaction for a broadband connection and message-based interaction for a narrowband connection.

The feature of an aggregation mechanism may also be used in the described method. It may be suitable to implement such an aggregation mechanism at the server side, in the metadata server node 202 or the media server node 204. As an example, network traffic conditions often vary over time, and there are patterns which may be identified over longer time periods which are not evident over shorter time periods. It may be of interest to adapt the composition of the metadata document to such patterns, especially trend information that may allow a quick adaptation to changes in conditions of interest. One measure that may be helpful is to calculate the derivative of the compound variation. When the derivative differs from zero, it can be concluded that conditions are changing. To aggregate information on network conditions, status reports, comprising information on network conditions, may be collected from several user equipments 200. For example it is possible to adapt the composition of the metadata documents so that all users having mobile user equipments 200 can receive media streams having low resolution during time periods when the traffic load is high in the mobile communication network. To retrieve information about time periods during which the traffic load is high, the aggregation mechanism as described above is used.

A further example of how the method can be used, is for control of advertising insertion in a program. The term “a commercial” is used in the meaning one sequence of advertising, e.g. one advertising sequence for a specific product. The term “advertisement” is also used in this meaning. This embodiment will be described with reference to FIG. 3. In this case, the following assumptions apply:

a. The program is composed of segments which are streamed from the media server node 304, a streaming server. The fact that the program is composed of segments may e.g. result from a decision by the user to accept programs including advertising or the program may only be available composed of segments meant to be followed by advertising.

b. Between the segments, advertisements are inserted. The advertisements or commercials may be downloaded in parallel to, or during, the streaming of the program segment after which they are to be inserted. The advertisements or commercials may hence be downloaded on a channel that is parallel, in time, to the streaming channel used for streaming the program segments. The channel used for downloading the advertisements or commercials may be separate from the channel used for the program segments. But the advertisements or commercials may also be downloaded on a channel that is not separate from the channel used for the program segments. When downloading the advertisements or commercials e.g. the HTTP GET (HyperText Transfer Protocol GET) may be used. The command HTTP GET is a function within the HTTP to request and receive information. The advertisements or commercials may e.g. be downloaded from the metadata server node 302, as indicated at 3:a′″, or from the media server node 104, 204, 304. Both for the streamed program segments and the advertisements or commercials, different ways of transmitting may be used, e.g. cable, satellite, Internet. The streamed program segments may e.g. be streamed from a media server node 104, 204, 304 where cable or satellite is part of the transmission path and the advertisements or commercials may be downloaded over the Internet.

The advertisements or commercials may also be streamed to the user equipment 300, e.g. from the media server node 304 and in that case the transmission and handling of the advertisements or commercials may be handled as described in the embodiment described above with reference to FIG. 2.

In the following it is assumed that the advertisements or commercials are downloaded on a parallel channel, e.g. through the HTTP GET, during the streaming of the program segment after which they are to be inserted. When advertisements or commercials are downloaded such a download may be composed of several parallel downloads.

c. Which advertisements that are to be inserted is controlled in an SMIL (Synchronized Multimedia Integration Language) document, or a document according to some other protocol or standard with similar functionality, which is downloaded to the user equipment 300 before the program segment is streamed. The SMIL document may be comprised in the metadata document downloaded into the cache unit 300I in step 3:a″.

d. The metadata document mentioned in the steps described below relates to advertisements. It is assumed that the user at the user equipment 300 selects a program, and hence initiates the transmission of a media stream, in some way, e.g. as described in the embodiment described with reference to FIG. 2. Hence, the user has initiated a session which may trigger the steps 3:a′ and 3:a″, where the session is performed with a system providing streamed media, e.g. an IPTV system or a VOD system.

The metadata server node 302 may comprise an arrangement 400 in a metadata server node, the arrangement 400 comprising a first receiving element 402, a metadata generating element 404 and a first transmitting element 406. Transport quality reports or status reports that are received at or by the metadata server node 302 may be received by the first receiving element 402 in the metadata server node 302. A metadata document that is composed in or by the metadata server node 302 may be composed and adapted by the metadata generating element 404 in the metadata server node 302. A metadata document that is sent from the metadata server node 302 may be sent by the first transmitting element 406 in the metadata server node 302.

Before the method of actually adapting the metadata controlling which advertisement or which version of a certain advertisement that is downloaded, is applied, the following steps may be performed, that are analogous to steps in the embodiment described with reference to FIG. 2:

3:a′: The user profile in the profiles database including rules 300B at the user equipment 300 is updated with the latest rule set from the profile database 308. This step is asynchronous and can take place at any time. This rule set comprises the preferences of the user regarding advertising.

3:a″: The cache unit 300I is provided with advertising metadata by transmitting an advertising metadata document from the metadata server node 302 to the user equipment 300. This can be done asynchronously from the process of transmissions and actions described below in steps 3:1-3:13. This transmission may be effected so that the cache unit 300I is provided with advertising metadata already before the user has requested or chosen a program. This may be an advantage since the user equipment 300 can process the received advertising metadata document before the first program segment is streamed. The asynchronous transmission 3:a″ of an advertising metadata document may take place as a result of a session having been initiated, i.e. without a user having specifically requested such information. The asynchronous transmission 3:a″ of an advertising metadata document may also take place because an update of the advertising metadata document is necessary. It may e.g. be the case that a commercial has been exchanged for another.

The steps 3:a′ and 3:a″ may be performed separately or they may be integrated in the steps 2:a′ respectively 2:a″.

However, the process wherein advertising metadata is adapted because of some conditions, e.g. network conditions, is triggered by an additional advertising metadata document being sent as described in step 3:1. It is assumed that this advertising metadata document is transmitted as a result of a user request of some kind, e.g. that the user has chosen or requested a program, where the user request eventually will result in a media stream being transmitted to the user equipment 300.

The method of actually adapting the metadata controlling which advertisement(s) or which version of a certain advertisement that will be downloaded or transmitted would then be applied as follows, the following steps being carried out:

3:1: A user makes a request of some kind, e.g. the user may request an EPG and therein chose a certain program. In this case it is assumed that the chosen program has advertisements linked to it. An advertising metadata document is downloaded into the cache unit 300I. The advertising metadata document may be sent by the first transmitting element 406 in the metadata server node 302. This step, 3:1, may be part of the step 3:a″ or 2:a″, i.e. the advertising metadata document may be part of, or associated with, the metadata document sent in step 2:a″.

3:2: The advertising metadata document is handed over or forwarded to the assertion engine 300C for parsing logic statements present in the advertising metadata document.

3:3: The resolved logic statements, resolved by the assertion engine 300C, or assertions, called advertising assertions, are handed over to the rules engine 300A. The advertising metadata document is turned into advertising assertions by the assertion engine 300C.

3:4: The rules engine 300A requests the personal profile of the user from the profiles database including rules 300B.

3:5: The personal profile of the user is returned to the rules engine 300A.

3:6: The rules engine 300A processes the personal profile of the user and the advertising assertions, as in the previous embodiment described with reference to FIG. 2, which results in a personalized processed advertising metadata document.

3:7: The rules engine 300A hands the personalized processed advertising metadata document to the media client 300D.

3:8: The media client 300D receives the media stream of the first program segment. The transmission of this media stream may e.g. be the result of the user having chosen a program from an EPG.

a. In parallel, the next advertising section or advertisements is/are downloaded in step 3:a′″. It may be helpful if several commercials or advertisements are downloaded, e.g. from the metadata server node 302 using the HTTP GET.

3:9: The media client 300D parses the received personalized processed advertising metadata document to verify which advertisement or commercial, of the ones received in step 3:8, should be used or displayed next.

a. The advertisement to be used or displayed is selected according to the user profile. Since advertisements can be repeated, and since not all advertisements may immediately be displayed, the advertisements in the cache unit 300I are used, and also additional advertisements, according to the personalized processed advertising metadata document, which are downloaded during the streaming of the program segment, may be selected as appropriate.

3:10: The media client 300D checks for the selected advertisement in the cache unit 300I.

3:11: The media client 300D receives the selected advertisement from the cache unit 300I in order to display the advertisement to the user.

3:12: The media client 300D sends a transport quality report or status report to the media server node 304, e.g. an RTCP report. This report comprises information about the transport conditions for the transmission path from the media server node 304 to the user equipment 300.

3:13: The media server node 304 informs the metadata server node 302 about the information in the transport quality report or status report and the process is repeated, starting from step 3:1, with an adapted advertising metadata document. The media server node 304 may e.g. forward the transport quality report to the metadata server node 302, where it may be received by the first receiving element 402.

a. The advertising metadata document can be adapted in that it refers to or contains information about advertisements or versions of advertisements that is suitable regarding the information in the status report. The advertising metadata document can be used to adapt the delivery of advertisements dependent on the network conditions, for instance by choosing or referring to advertisements which have an appropriate bandwidth. The advertisements are available in several versions with different bandwidth requirements and depending on the network conditions the appropriate version is selected and referred to in the advertising metadata document. The advertising metadata document may be composed and adapted by the metadata generating element 404 in the metadata server node 302.

In this scenario it is assumed that the status report regarding the network conditions for the transmission path from the media server node 304 to the user equipment 300 is valid or relevant also for the transmission path of the advertisements. The transmission path of the advertisements may e.g. be the transmission path from the metadata server node 302 to the user equipment 300.

The media client 100D, 200D, 300D is adapted to receive media content, to process media content and to output media content to a display device 100E, 200E, 300E so that it can be viewed by a user.

Generally, the media stream is transmitted from the media server node 104, 204, 304 to the user equipment 100, 200, 300 via a transport network 106, 206, 306. Regarding network conditions, the transmission path from the media server node 104, 204, 304 to the user equipment 100, 200, 300 is substantially the same each time a media stream is transmitted from the media server node 104, 204, 304 to the user equipment 100, 200, 300. The transmission path which is used for the transmission of the metadata document from the metadata server node 102, 202, 302 to the user equipment 100, 200, 300 may differ from the one used for the media stream but it may also be the same.

The user equipment 100, 200, 300, metadata server node 102, 202, 302, media server node 104, 204, 304, transport network 106, 206, 306 and profile database 108, 208, 308 may have substantially the same characteristics in the different embodiments. Although the functionality of these items may differ in the different embodiments, as implied by the differences in the different embodiments.

The profile database 208, 308 contains several user profiles. The profiles database including rules 200B, 300B contains one user profile.

The user equipment 100, 200, 300 may comprise an arrangement in user equipment 500 comprising a second receiving element 502, a personalizing element 504, a second transmitting element 506 and a media client 508.

The second receiving element 502 is adapted to perform all or part of the functions performed by the cache unit 200I, 300I and/or the receiving unit 110.

The personalizing element 504 is adapted to perform all or part of the functions performed by the assertion engine 200C, 300C, the profiles database with rules 200B, 300B and the rules engine 200A, 300A. The personalizing element 504 may as well be adapted to perform all or part of the functions performed by the processing unit 112.

The second transmitting element 506 is adapted to transmit individualized or personalized metadata to the media client 508. Hence, it is not necessary that the personalizing element 504 is adapted to transmit such data to the media client 508.

The media client 508 is adapted to perform all or part of the functions performed by the media client 100D, 200D, 300D.

Hence, the arrangement in user equipment 500 including its elements 502 to 508 is an alternative way of implementing the functionality of the user equipment 100, 200, 300 as compared to that illustrated in FIGS. 1-3.

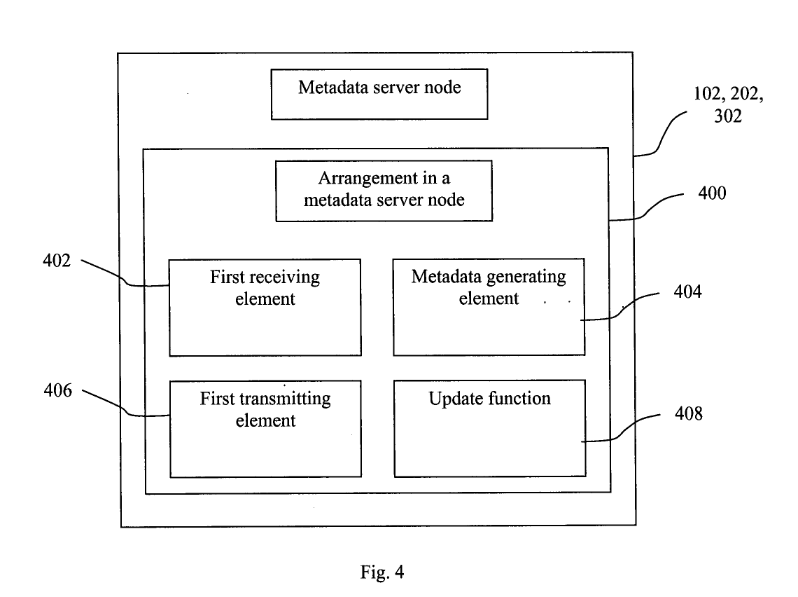

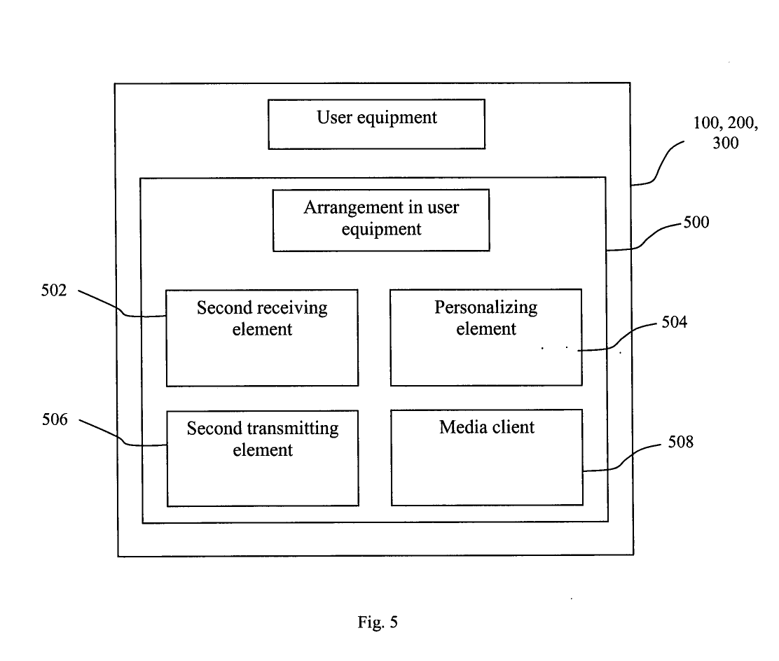

The elements in the arrangements illustrated in FIGS. 4 and 5 may be implemented in a different manner than shown. The elements may e.g. be merged into fewer elements but they may also be split up in sub-elements.

Although particular embodiments have been disclosed herein in detail, this has been done by way of example for purposes of illustration only, and is not intended to be limiting with respect to the scope of the appended claims that follow. In particular, it is contemplated by the inventor that various substitutions, alterations, and modifications may be made to the invention without departing from the spirit and scope of the invention as defined by the claims.

1-24. (canceled)

25. A method, executed in a metadata server node connected to a communication network for delivering media streams from a media server node to user equipment, of providing metadata which is transmitted from the metadata server node to the user equipment and is related to media content, the method comprising the following steps:
a. receiving status information relating to conditions in at least one of:
the communication network and the user equipment;
b. generating the metadata wherein the metadata is adapted considering the status information; and
c. transmitting the generated metadata to the user equipment.

26. The method of claim 25, wherein the metadata is adapted to contain references to such media content that is suitable considering the status information.

27. The method of claim 25, wherein the status information is received from the media server node.

28. The method of claim 25, wherein the status information is received from the user equipment.

29. The method of claim 25, wherein the conditions include at least one of:
transport conditions, user equipment conditions and user equipment device characteristics.

30. The method of claim 25, wherein, in the step of generating the metadata, status information is used that is related to the transmission of a media stream from the media server node to the user equipment.

31. The method of claim 25, wherein, in the step of generating the metadata, status information is used that is related to the conditions at the user equipment.

32. A method according to claim 31, wherein the status information comprises user equipment device characteristics.

33. An arrangement in a metadata server node configured to connect to a communication network for delivering media streams from a media server node to user equipment, for providing metadata which is transmitted from the metadata server node to the user equipment and is related to media content, the arrangement comprising:
a first receiving element for receiving status information relating to conditions in at least one of: the communication network, and the user equipment;
a metadata generating element for generating the metadata wherein the metadata is adapted considering the status information; and
a first transmitting element for transmitting the generated metadata to the user equipment.

34. The arrangement of claim 33, wherein the metadata generating element is adapted to adapt the metadata to contain references to such media content that is suitable considering the status information.

35. The arrangement of claim 33, wherein the first receiving element is adapted to receive status information from the media server node.

36. The arrangement of claim 33, wherein the first receiving element is adapted to receive status information from the user equipment.

37. The arrangement of claim 33, wherein the first receiving element is adapted to receive status information relating to conditions which include at least one of:
transport conditions, user equipment conditions and user equipment device characteristics.

38. The arrangement of claim 33, wherein the metadata generating element is adapted to use status information that is related to the transmission of a media stream from the media server node to the user equipment.

39. The arrangement of claim 33, wherein the metadata generating element is adapted to use status information that is related to the conditions at the user equipment.

40. The arrangement of claim 39, wherein the metadata generating element is adapted to use status information that is related to user equipment device characteristics.

41. A method, executed in user equipment connected to a communication network, the communication network being adapted for delivering media streams from a media server node to user equipment, of using metadata which is received at the user equipment from a metadata server node and is related to media content, the method comprising the following steps:
a. receiving adapted metadata, which is adapted considering status information;
b. personalizing the adapted metadata using user profile information;
c. transmitting the personalized adapted metadata to a media client; and
d. displaying media content to a user:
wherein the displayed media content comprises the personalized adapted metadata; or,
wherein the displayed media content is selected based on the personalized adapted metadata.

42. The method of claim 41, wherein, in the step of displaying media content to a user, the following is performed: sending a request for transmission of media content, the request being sent from the user equipment to the media server node or to the metadata server node, the requested media content being requested on the basis of the personalized adapted metadata.

43. The method of claim 42, wherein, in the step of personalizing the adapted metadata, assertions are derived by parsing logical statements present in the received adapted metadata.

44. The method of claim 43, wherein, in the step of personalizing the adapted metadata, user profile information in the form of rules are applied to the derived assertions thereby creating personalized adapted metadata.

45. An arrangement in a user equipment configured to be connected to a communication network, the communication network being adapted for delivering media streams from a media server node to user equipment, for using metadata which is received at the user equipment from a metadata server node and is related to media content, the arrangement comprising:
a second receiving element for receiving adapted metadata, which is adapted considering status information;
a personalizing element for personalizing the adapted metadata using user profile information;
a second transmitting element for transmitting the personalized adapted metadata to a media client, the media client being adapted to receive media content, to process media content and to output media content to a display device so that it can be viewed by a user; and
a media client for displaying media content to a user by outputting media content to a display device;
wherein the displayed media content comprises the personalized adapted meta data, or wherein the displayed media content is selected based on the personalized adapted metadata.

46. The arrangement of claim 45, wherein the media client is adapted to send a request, for transmission of media content, from the user equipment to the media server node or to the metadata server node, the requested media content being requested on the basis of the personalized adapted metadata.

47. The arrangement of claim 45, wherein the personalizing element is adapted to derive assertions by parsing logical statements present in the received adapted metadata.

48. The arrangement of claim 47, wherein the personalizing element is adapted to apply user profile information in the form of rules to the derived assertions thereby creating personalized adapted metadata.
